(19) United States
(12) Patent Application Publication
(10) Pub. No.: US 2024/0079990 A1
(43) Pub. Date: Mar. 7, 2024

(54) South Facing Mounting System

(71) Applicant: K2 Systems, LLC, Oceanside, CA (US)

(72) Inventors: Ryan Hagen, Vista, CA (US); Jose Ismael Amador Acosta, Chalco (MX); Brett Nielsen, Queen Creek, AZ (US)

(21) Appl. No.: 18/459,750

(22) Filed: Sep. 1, 2023

Related U.S. Application Data
(60) Provisional application No. 63/403,184, filed on Sep. 1, 2022.

(51) Int. Cl. H02S 20/30; H02S 20/24

(52) U.S. Cl. CPC H02S 20/30; H02S 20/24

(57) ABSTRACT

A bay-styled PV array mounting system for use on support structures. In an aspect, the bay-styled PV array mounting system includes bay areas for receiving PV modules. In an aspect, the bay-styled PV array mounting system can mount PV modules in landscape or portrait configurations.

### FIELD OF INVENTION

This invention generally relates to photovoltaic arrays, and more particularly to a bay-styled system for mounting of photovoltaic (PV) arrays and associated hardware.

### BACKGROUND OF THE INVENTION

A photovoltaic (PV) installation typically includes a collection of photovoltaic modules combined and secured to a support structure that combines each of the photovoltaic components to form a photovoltaic array. Typically, photovoltaic arrays are placed in an outdoor location, commonly rooftops, so that the photovoltaic arrays are exposed to sunlight in order to produce electricity. PV arrays are mounted using rail-based systems or rail-less systems (i.e. “bay style” systems). PV modules in rail-less systems are not rigidly connected to metal rails or structures and are instead held in individual “bays” used to connect PV modules.

PV installations can occur on flat roofs and/or sloped roofs. Flat roofs may be defined as having a maximum roof pitch of about 2-in-12, meaning that the roof rises about 2 inches for every 12 inches it extends, leading to an angle of about 9.5 degrees. Flat roof solar arrays are not as efficient at producing power as their pitched (i.e. more angled) roof counterparts when arrays are mounted flush to the roof. The efficiency differences become more apparent the further away from the equator the roof that an array is installed on is located. For this reason, it is typical to tilt the array toward the sun on flat roof solar installs. Maximum module efficiency over a year is achieved by facing modules south (north in the southern hemisphere) having a tilt corresponding to the latitude of the install. While installing based on required latitude tilt is the most efficient install per module, it is not necessarily the optimal tilt for an entire array.

There is a consensus in the industry that a 10-degree tilt for a flat roof system is optimal for a variety of reasons including, but not limited to, module efficiency, array density, and soiling effects. A solar array tilted at 10 degrees towards the south yields higher efficiency compared to a system with no tilt or tilt less than 10 degrees. This is true of all installs in the contiguous United States and most installs in Northern Mexico. Arrays tilted higher than 10 degrees may require larger inter-row spacing (i.e., spacing between rows) due to the shadow cast by modules of one row on modules of another row. The effect of larger inter-row spacing is a lower array density of modules, leading to a decrease in overall modules capable of being placed on a roof.

The latitude of a location where a system is installed may serve as another factor affecting inter-row spacing. A higher latitude requires a larger inter-row spacing due to the varied angle incidence from the sun, which changes at different latitudes as well during different seasons. Adjustable inter-row spacing is common on rail-based flat roof racking systems; however, this is difficult to achieve with bay-style systems in either portrait or landscape orientations. Traditionally, bay-style systems use fixed inter-row spacing.

Another factor affecting array density is the geometry of the racking itself. The array size is increased by racking protruding from the foot print of the solar modules. Lastly, soiling (i.e. the accumulation of snow, dirt, dust, leaves, pollen, bird droppings, or any obstruction which restricts the amount of light reaching the solar module) will affect the efficiency of the module. A 10-degree tilt allows proper clearing of soiling when it rains.

Therefore, there is a need for a south facing PV mounting system that addresses the short-comings discussed above.

### SUMMARY OF THE INVENTION

In an aspect, the present disclosure relates to a bay-styled photovoltaic (PV) mounting system for mounting PV modules to be placed on a roof. Roofs can be flat roofs or commercial roofs. The PV mounting system is made of multiple components including, but not limited to, a mounting ridge configured to receive a PV module, mounting mats configured to receive the mounting ridge, and a securing device that secures the PV module onto the mounting ridge. In such aspects, the aforementioned components can mount PV modules in portrait or landscape orientations and together (i.e. as a system) prevent a roof from being damaged. In an aspect, the PV mounting system is configured as to allow for adjustable inter-row spacing of a photovoltaic array. In such an aspect, the securing device of a PV mounting system can be adjusted to allow for adjustable inter-row spacing.

In an aspect, a mounting ridge includes bottom and cross members, the cross members configured to be received by the mounting mats. In addition, the mounting ridge includes a raised mounting portion that supports one end of a PV module and an additional mounting portion that supports the opposing end of a PV module. The mounting ridge can include several support members that run perpendicular to the cross members to offer additional rigidity.

In an aspect, the mounting mats include a mounting channel that retain a cross member of the mounting ridge. The mounting mats can also include stabilizing side arms configured to engage a top surface of a roof. The mounting mats can include a hollow middle channel and/or bottom side channels configured to expand and contract to dissipate thermal expansion and seismic loads. In addition, the mounting mats can include a bottom stabilizing member configured to allow for a plurality of mounting mats to be stackable with one another.

In an aspect, the securing device of the mounting system can include a module end clamp. The module end claim includes a rail mount component configured to interface with the mounting ridge and a module securing component configured to engage with a mounted PV module. The rail mount component of the module end clamp can be configured to interface with a slot of the mounting ridge, allowing the module end clamp to be adjustably secured to the mounting ridge.

In an aspect, a PV mounting system can utilize further mounting components in addition to a mounting ridge. In such an aspect, a PV mounting system can utilize mounting summit(s), wherein mounting summit(s) receive a portion of a PV module, and mounting valley(s), wherein mounting valley(s) also receive a portion of a photovoltaic module. In such aspects, mounting summit(s) and mounting valley(s) are also configured to join to mounting mats and securing devices in a similar fashion to a mounting ridge.

In an aspect, a PV mounting system can utilize further components in addition to mounting components. In such an aspect, a PV mounting system can use ballasts or anchors to secure the system to a roof, wherein the ballasts or anchors do not necessitate penetrating or damaging the roof. In such aspects, ballasts or anchors can be received within mounting components of a PV mounting system. Anchors of the system can be adjusted within the system, wherein anchors can be moved north, east, south, and west. In an aspect, a PV mounting system can also use components, such as a Universal Module Frame Mounting Kit and accessory mounting hardware (AMH). This allows the PV mounting system to mount accessories including, but not limited to, microinverters, wind skirts, and fire skirts to the PV mounting system. In an aspect, a PV mounting system also contains hooks within the system, which allows for a PV module to rest on a component of the system before engaging a securing device. In such an aspect, ease of installation is improved.

In an aspect, several components of a PV mounting system are stackable including, but not limited to, mounting ridges, mounting summits, mounting valleys, and mats. In such aspects, stacking may facilitate ease of storage or transportation. In an aspect, mats may also be stacked during use of a PV mounting system to allow the system to have adjustable heights.

In an aspect, a PV mounting system can be used to prevent damage to a roof and thermal migration of PV modules placed on the roof. In order to do so, PV modules are mounted onto the PV mounting system by arranging the adjustable PV mounting system on the roof, positioning PV modules onto the mounting system, and securing the modules to the system using the securing device(s) of the mounting system. During mounting, inter-row spacing can be selected through the adjustable securing devices. As previously described, a hook can be used prior to engagement of the securing device(s) to facilitate ease of installation.

These and other objects and advantages of the invention will become apparent from the following detailed description of the preferred embodiment of the invention. Both the foregoing general description and the following detailed description are exemplary and explanatory only and are intended to provide further explanation of the invention as claimed.

The accompanying drawings are included to provide a further understanding of the invention and are incorporated in and constitute part of this specification, as well as illustrate several embodiments of the invention that together with the description serve to explain the principles of the invention.

### BRIEF DESCRIPTION OF THE FIGURES

FIG. 1 displays a top view of a photovoltaic array mounted in a landscape orientation according to an aspect of the current invention.

FIG. 2 displays a top view of a photovoltaic array mounted in a portrait orientation according to an aspect of the current invention.

FIGS. 3A-3B depicts a mounting ridge component of the current invention configured to be joined with mounting mats.

FIGS. 4A-4B show a top view of a singular mat (FIG. 4A) and a plan view of two stacked mats (FIG. 4B) according to aspects of the current invention.

FIGS. 5A-5B show a top view of a singular mat (FIG. 5A) and a plan view of two stacked mats (FIG. 5B) according to aspects of the current invention.

FIG. 6 shows a rotated view of a module end clamp according to the current invention.

FIG. 7 displays a configuration using a mounting ridge, a module end clamp, and a mounting mat to mount a photovoltaic module in an aspect according to the current invention.

FIG. 8 depicts a module end clamp located within a slot of a portion of a mounting ridge in an aspect of the current invention.

FIG. 9 shows a top view of a slot configured to receive a module end clamp in order to afford adjustable inter-row spacing in a manner according to the current invention.

FIG. 10 depicts a portion of a mounting ridge according to the current invention, wherein the ridge contains a hook.

FIGS. 11A-11B depict a mounting summit component of the current invention configured to be joined with mounting mats.

FIG. 12 depicts a mounting valley component of the current invention configured to be joined with mounting mats.

FIG. 13 displays a top view of a photovoltaic array mounted using mounting ridges, summits, and valleys in an aspect according to the current invention.

FIGS. 14A-14D display manners of configuring ballasts to the mounting system (FIG. 14A), ridge (FIG. 14B), summit (FIG. 14C), and valley (FIG. 14D) of the current invention.

FIGS. 15A-15B depict manners of configuring anchors to the components of the current invention.

FIG. 16 shows a bottom view of a Universal Module Frame Mounting Kit installed directly onto a photovoltaic module frame.

FIG. 17 displays a front plan view of a portion of a mounting component containing an aperture for mounting a Universal Module Frame Mounting Kit onto the chassis.

FIGS. 18A-18D display a top view (FIG. 18A) and a side view (FIG. 18B) of stacked mounting components without mats and a top view (FIG. 18C) and a side view (FIG. 18D) of stacked mounting components with mats according to methods of the current invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the following description, numerous specific details are set forth. However, it is to be understood that embodiments of the invention may be practiced without these specific details. In other instances, well-known methods, structures, and techniques have been shown in detail in order not to obscure an understanding of this description.

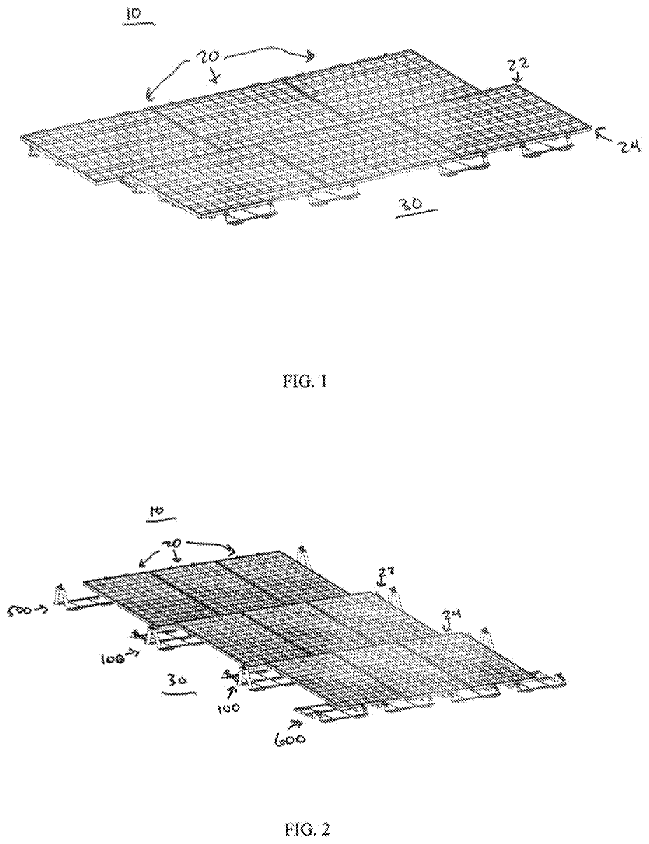

In an aspect, the current invention relates to a bay-styled photovoltaic (PV) array mounting system 10, as shown in FIGS. 1-18D. The bay-styled mounting system 10 can be configured to mount PV modules 20 in either a landscape (FIG. 1) or portrait (FIG. 2) configuration. In an aspect, the mounting system 10 is optimized for use on flat or commercial style roofs 30, and is configured to be south-facing such that the amount of sun received on the photovoltaic modules 20 is maximized. In such an aspect, the PV modules 20 may be maintained at an angle of about 10 up to about 12 degrees in landscape orientations (i.e., the module is oriented to have a greater length verses height) and about 5 up to about 7 degrees in portrait orientations (module is oriented with the height greater than the length), allowing for ideal array density and design flexibility on all installs. In such aspects, ideal array density may refer to having the most PV modules 20 that can physically fit on a roof 30 without any shading from row to row of PV modules 20. Ideal array density varies on the location of install (latitude) and tilt angle of the PV modules 20. In such an aspect, portrait orientations, wherein PV modules 20 may be mounted from about 5 up to about 7 degrees, may be beneficial for arrays installed at locations closer to the equator. Such locations benefit from lower mounting angles due to their respective angle of incidence of light rays from the sun. In an additional aspect, the mounting system 10 is configured such that need for roof penetration during installation is removed, allowing for the use of a bay-styled mounting system 10 that does not damage the roof upon installation. Instead, non-roof-penetrating methods of securing the system are used, as will be described below. In an additional aspect, the mounting system 10 can accommodate any size PV module 20, as will be described below.

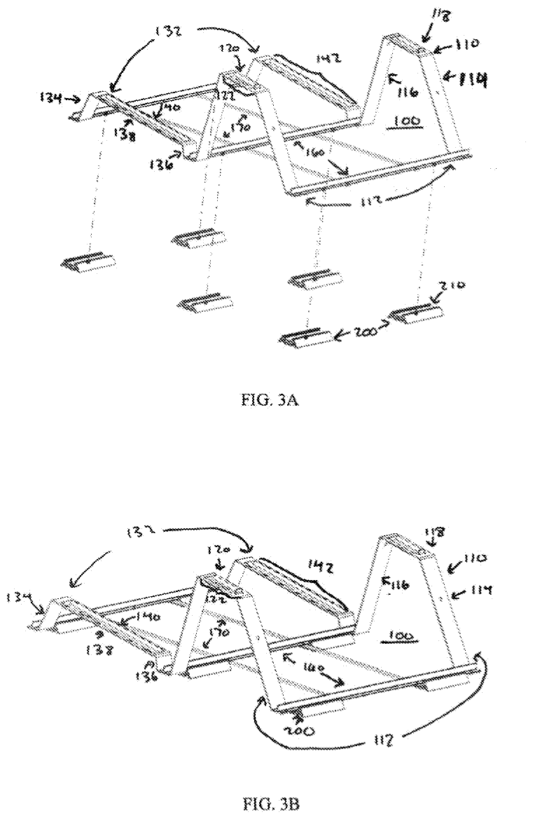

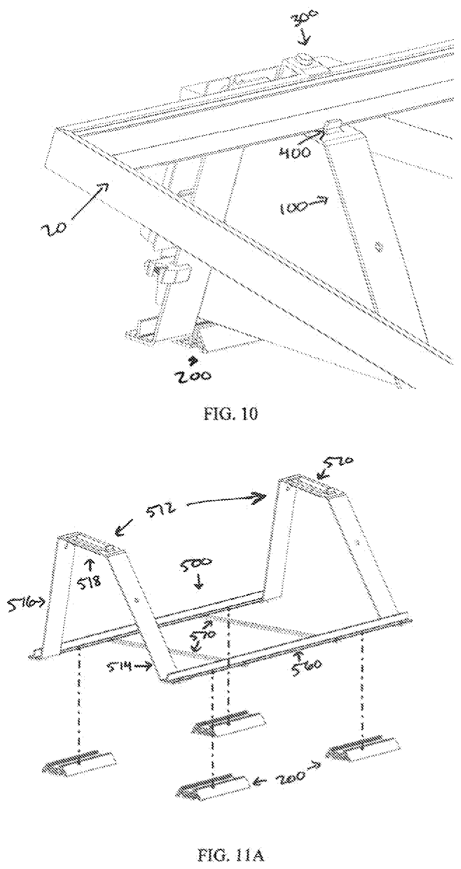

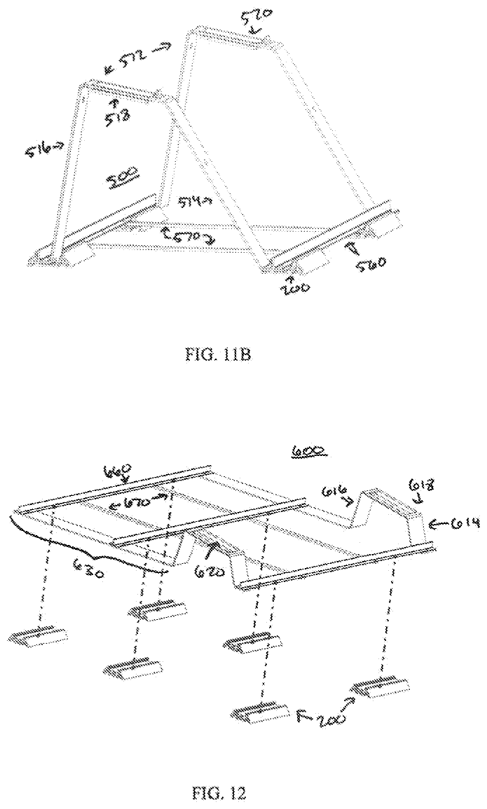

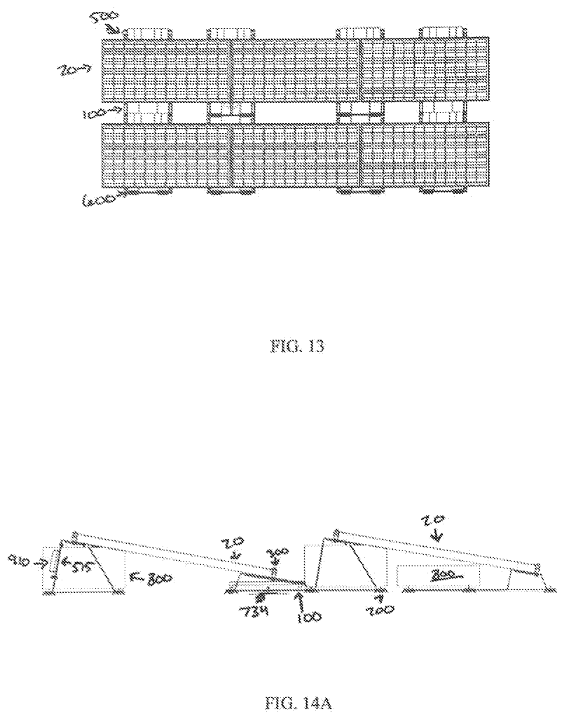

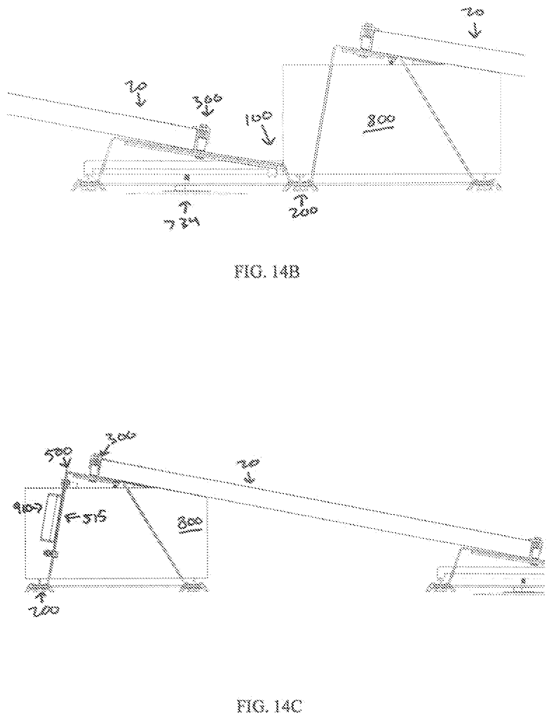

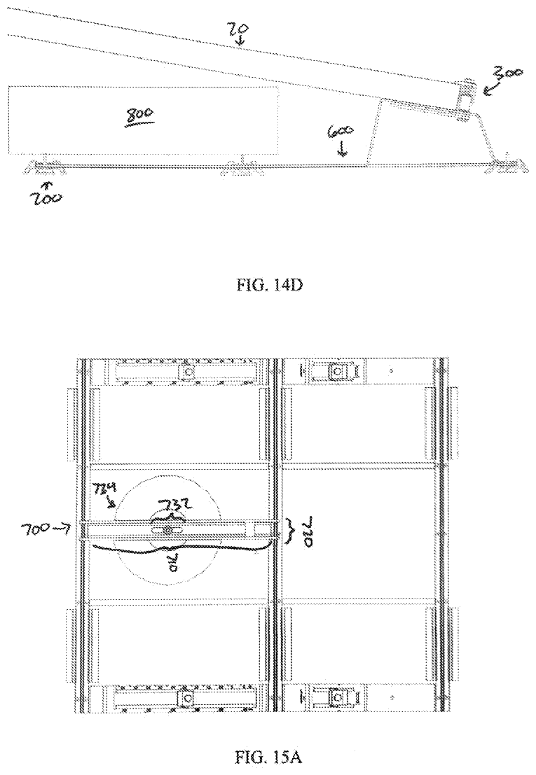

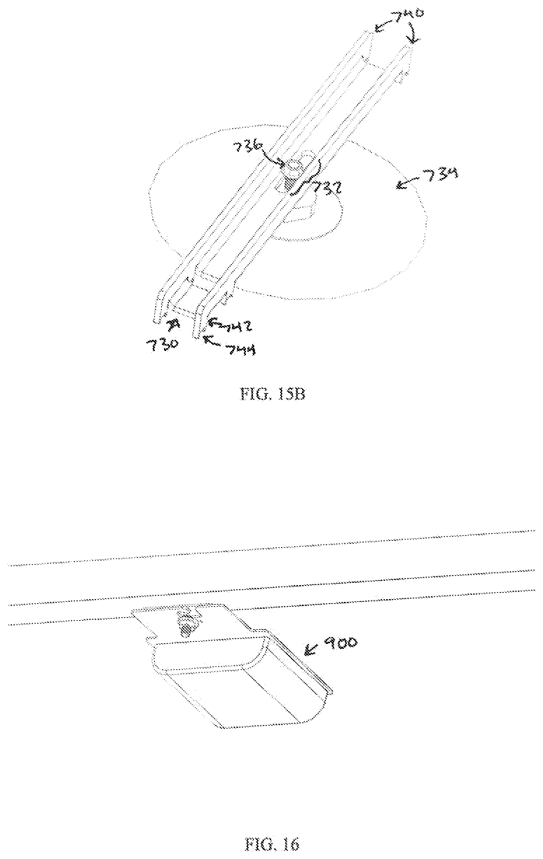

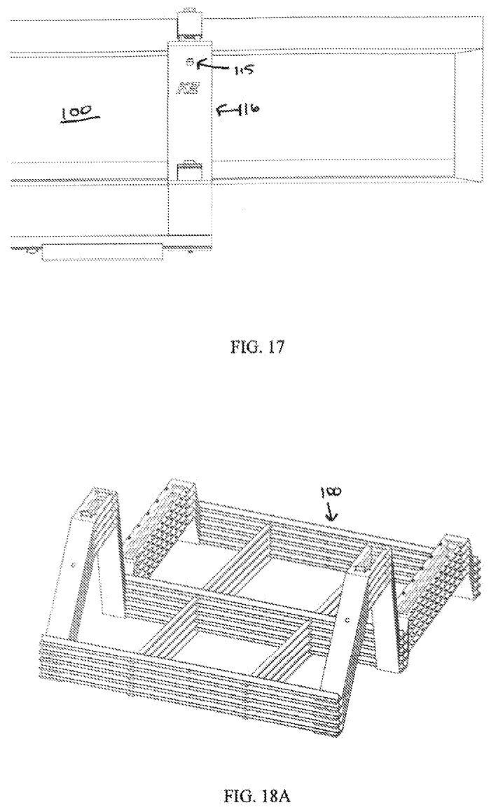

The PV array mounting system 10 includes a mounting ridge 100, mounting mat(s) 200, and a module-end clamp 300, as shown in FIGS. 3-18D. Other embodiments of the mounting system 10 include various other components, including, but not limited to, a hook 400 (See FIG. 10), a south face summit 500 (See FIGS. 11A-11B), a south face valley 600 (See FIG. 12), one or more anchor bracket(s) 700 (See FIGS. 15A-15B), one or more ballast(s) 800 (See FIGS. 14A-14D), and a Universal Module Frame Mounting Kit 900 (FIGS. 16-17), as will be described further below. While the other components are optional, the mounting ridge 100, mounting mat 200, and module-end clamp 300 are central to the overall function of the PV array mounting system 10.

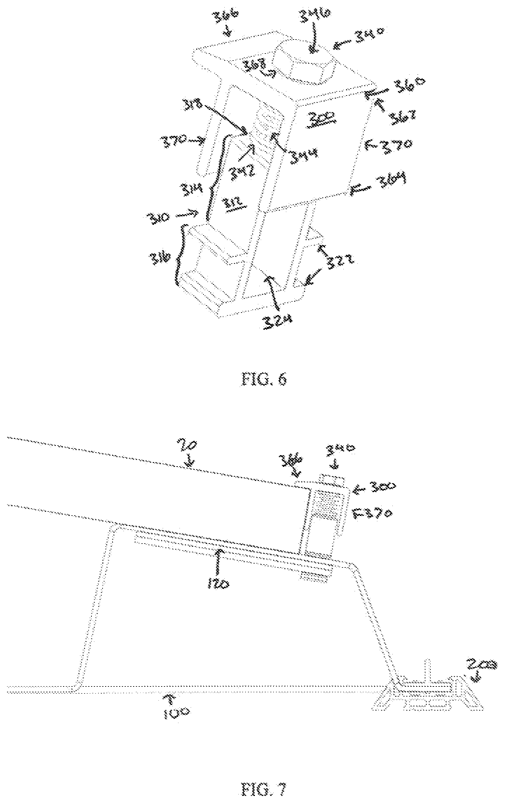

In an aspect, the mounting ridge 100 comprises a raised portion 110 and a lower portion 130, wherein the raised portion 110 is configured to support one end of a PV module 22 while the lower portion 130 is configured to support the opposing end of a PV module 24, as shown in FIGS. 2 and 3A-B. In an exemplary aspect of the invention, the raised portion 110 of the mounting ridge 100 comprises two mount members 112, wherein each mount member 112 comprises an angled support member 114 and a vertical support member 116, as shown in FIGS. 3A-3B, with the vertical support member 116 being closer to a 90 degree angle with the roof surface than the angled support member 114. In an additional aspect, the raised portion 110 comprises a horizontal support member 118 connecting the angled support member 114 and vertical support member 116 of each mount member 112. The horizontal support member 118 may be configured to include a slot 120, wherein a module end clamp 300 (see FIG. 6-9) may be received, as will be discussed in further detail below. In an aspect, such a slot 120 may comprise a length 122, as shown in FIGS. 3A-3B, of about 8 inches up to about 18 inches to receive the module end clamp 300, though other dimensions are possible. The slot 120 affords the mounting ridge 100 the feature of adjustable inter-row spacing of mounted PV modules 20, wherein a module end clamp 300 can be secured at various locations within the slot 120, as shown in FIG. 9. Adjustable inter-row spacing allows for optimizing inter-row spacing of modules 20, depending on various factors described herein. Such factors may comprise shadows cast by other modules 20 in an array, varied angle incidences of sun light at different latitudes of install location or during different seasons, and other such factors known in the art. As a non-limiting example, lower inter-row spacing may be required at locations closer to the equator, wherein a portrait orientation and low tilt angles may be used. Adjustable inter-row spacing allows for array density optimization in such an example.

In an aspect, as shown in FIGS. 3A-B, the lower portion 130 of the mounting ridge 100 includes two mount members 132, wherein each mount member 132 comprises an angled support member 134 and a vertical support member 136, as shown in FIGS. 3A-3B. Similar to the upper portion 110, the vertical support member 136 is closer to a 90-degree angle with the roof surface than the angled support member 134. The lower portion 130 can include a horizontal support member 138 connecting the angled support member 134 and vertical support member 136 of each mount member 132. The horizontal support member 138 can include a slot 140, wherein a module end clamp 300 may be received, as will be discussed in further detail below. Such a slot 140 may comprise a length 142 of about 8 inches up to about 18 inches, though other dimensions may be possible.

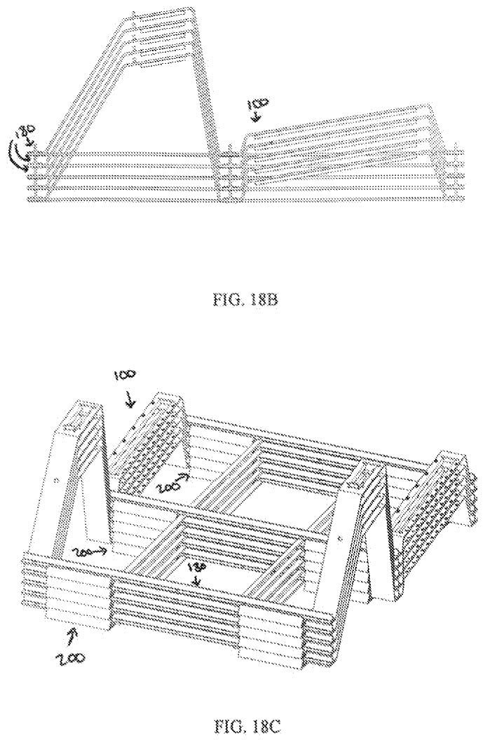

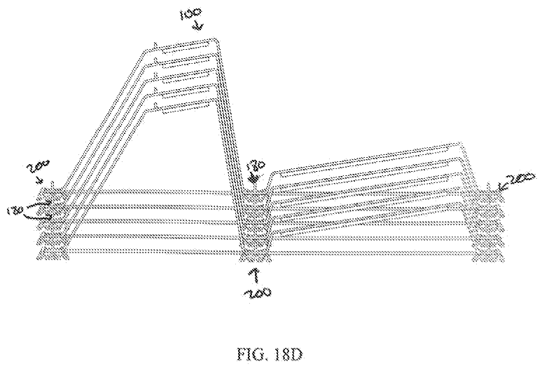

In an aspect, the mount members 112 and 132 of the raised portion 110 and lower portion 130, respectively, of the mounting ridge 100 may be connected by cross members 160 that run perpendicular to the direction of the mount members 112 and 132. In an additional aspect, another set of cross members 170 may be configured to run perpendicular to the previously described cross members 160, substantially connecting the first set of cross members 160. In such an aspect, the use of two sets of cross members 160 and 170 running perpendicular to each other affords the mounting ridge 100 increased rigidity. In an aspect, a mounting ridge 100 can also include ballast supports 180, as described below. In an additional aspect, the geometry of the mounting ridge 100 allows multiple mounting ridges 100 to be stacked, as shown in FIGS. 18A-18D. This stackable nature of the mounting ridges 100 facilitates easier transportation. In an aspect, the mounting ridge 100 may comprise a multi-material metal chassis. Such materials are configured to be conductive and resistant to atmospheric corrosion. The metal chassis can be made from zinc aluminum magnesium coated steel, galvanized steel, other alloys of steel, aluminum, AL 6000 series alloys and other metals known to those skilled in the art.

In an aspect, the current invention includes mounting mats 200 configured to receive mounting components (e.g. mounting ridges 100, south face summits 500, and south face valleys 600) of the array mounting system 10 to be securely mounted on roofs 30. Mounting mats 200 allow the array mounting system 10 to withstand seismic loads, snow loads, thermal expansion effects, wind loads, and other such stresses known in the art, as described further below. The weight of the mounting components (100, 500, 600) and additional parts of the array mounting system 10 and the geometry of the mounting mats 200, discussed below, create a secured mounting for the system 10. Further, the mats 200 prevent the roof 30 from being damaged by eradicating the need for roof-penetrating mounting equipment.

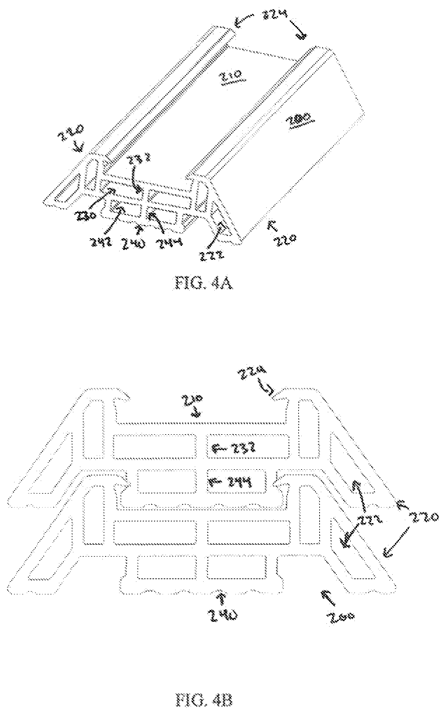

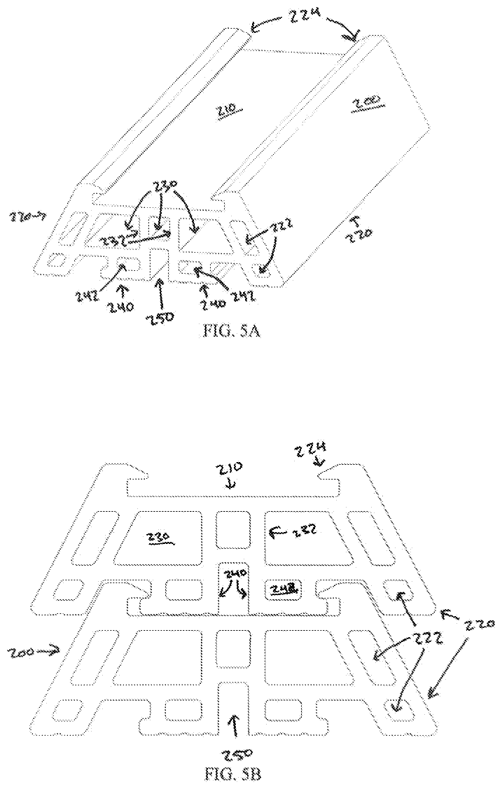

Mats 200 can be placed onto a roof 30 and have a mounting component (e.g., mounting ridge 100) joined to them, as described herein. In an additional aspect, mats 200 can be joined to the mounting component prior to a mounting component being placed on a roof 30. In such an aspect, a mat 200 would be joined to a mounting component, and the combination (i.e. mat 200 and mounting component) would be placed on a roof 30. Moreover, a mounting system 10 can simply be placed onto a roof 30, with the mounting mats 200 in direct contact with the roof 30 while being joined to mounting components (e.g. the mounting ridge 100 being joined to the mat 200 at a cross member 160). In such an aspect, the mats 200, as a result of their material and geometry, dissipate thermal expansion and seismic loads to prevent movement (sometimes referred to as caterpillaring) of the mounted PV array 20, which in turn removes the need for using roof-penetrating fasteners. This combination additionally allows mats 200 to prevent movement of a mounting system 10 when PV modules 20 are being mounted to the system 10. Shifting of a mounting system 10 during or after mounting of PV modules 20 can be sufficiently reduced or eliminated as a result of the mats 200. In situations where mats 200 need additional support to maintain the position of a mounting system 10 and mounted PV modules 20, anchors 700 and ballasts 800 can be used, as described below. Mats 200 may also be stacked upon one another (See FIGS. 4B and 5B) for ease of shipping and also to afford additional height adjustment capability to the mounting system 10, as multiple mats 200 can be stacked and then clipped onto a mounting component (e.g. mounting ridges 100). Methods of mat functionality will be described further below.

The mounting ridge 100 may be configured to interface with mounting mats 200 of the current invention, as well as the roof 30, as shown in FIGS. 3-5B and described below. The mounting mats 200 can be configured to receive cross members 160, at various positions along the cross members 160, of the mounting ridge 100. For example, the mounting ridge 100 can be received by a total of six mounting mats 200, as shown in FIG. 3A. However, additional or fewer mats 200 could be used at various locations along the cross members 160.

In an aspect, the mats 200 comprise a mounting channel 210, wherein a member of a mounting component (e.g. cross member 160 of a mounting ridge 100) may snap in, thus securing the mat 200 to the mounting component, as shown in FIGS. 4A-5B. As non-limiting examples, mats 200 may be configured to join to members of a mounting component about one-quarter or one-sixth of the length of a PV module 20 away from the end of the module 20, though clamping location should be optimized per install. By optimizing the location where a mat 200 joins a mounting component (e.g., cross member 160 of the mounting ridge 100), the loads (e.g. wind load, seismic load, etc.) which a mounting array 10 may withstand can be increased. The mat 200 further comprises two stabilizing side arms 220 connected to the sides of the mounting channel 210. Stabilizing arms 220 may help to stabilize a mat 200 on a roof 30 and may also facilitate easier stacking of mats 200 onto each other when necessary. Stacking of mats 200, as well as joining of mats 200 onto mounting components, may be facilitated by notches 224 located at the portion of stabilizing arms 220 abutting the mounting channel 210.

In an aspect, the arms 220 extend diagonally outwards. Each stabilizing arm 220 has a hollow interior channel 222. Below the mounting channel 210, the mounting mat 200 comprises a hollow middle channel 230, which plays a part in thermal stress dissipation and seismic load tolerance. Within the hollow middle channel 230 is located a separating wall 232, which is configured to act as a structural support. The separating wall 232 allows individual mats to support necessary loads to prevent deformation. In an aspect, the mat 200 further comprises a bottom stabilizing member 240, which itself has a hollow channel 242 and an inner wall 244. The stabilizing member 240 allows the mats 200 to effectively stack on each other to provide shipping advantages and potential added height to the mounting system 10, as described above and shown in FIG. 4B. In doing so, the bottom stabilizing member 240 of one mat 200 can be inserted into the mounting channel 210 of another mat 200 to allow stacking.

In an aspect, the combination of the geometry of the mounting mat 200 (i.e. shape of supports and mat in addition to presence of various hollow channels) allows the mat 200 to effectively dissipate thermal stress and seismic loads in a manner that prevents movement/caterpillaring of the mounting system 10 on the roof 30. The large surface area of the mats distributes weight of a PV array 20 over the surface of a roof 30 and decreases point loads, which may damage the roof 30. In addition to the geometry, the mat 200 is also made of an elastomeric material, which helps to serve these functions as well by providing the mat 200 with a high coefficient of friction. In such an aspect, the mat 200 may be comprised of a rubber. As non-limiting examples, the mat 200 may be comprised of ethylene propylene diene monomer (EPDM) Shore 70, EPDM Shore 80, butyl rubbers, recycled tire rubbers and other materials known to those skilled in the art.

In additional aspects, various additional configurations of mounting mats 200 may be used. The selection of a specific configuration may result from a number of factors including but not limited to stackability requirements. As a non-limiting example, an additional mat 200 configuration is shown in FIGS. 5A-5B. Such a mat 200 configuration comprises similar functionalities (e.g. thermal dissipation, seismic load management, roof damage prevention, and the like) and components as the above described mat 200. In such an aspect, the exemplary mat 200 configuration in FIGS. 5A-5B includes a mounting channel 210, one or more stabilizing arms 220, one or more hollow interior portions 222 positioned within one or more stabilizing arms 220, one or more notches 224 configured to facilitate the coupling of a mounting mat 200 to a mounting component, one or more hollow middle channels 230, one or more separating walls 232 positioned between one or more hollow middle channels 230, one or more stabilizing members 240, and one or more hollow interiors 242 of one or more stabilizing members 240. In an additional aspect, the configuration of a mounting mat 200 displayed in FIGS. 5A-5B includes additional features not shared with the mounting mat 200 configuration displayed in FIGS. 4A-4B. In such an aspect, the configuration in FIGS. 5A-5B includes a hollow channel 250 sandwiched by two or more stabilizing members 240. A hollow channel 250 may allow for additional stackability functionalities. In such an aspect, a hollow channel 250 may allow for mats 200 to be pre-assembled onto a mounting component without sacrificing stackability. In an additional aspect, a hollow channel 250 may allow a mounting component to stack onto the ballast support 180, 580, 680 of another mounting component, as shown in FIGS. 18C-18D. In such an aspect, the hollow channel 250 may allow secure stacking while not adding too much height during stacking. In such an aspect, such stacking allows for ease of storage and transportation. It is to be understood that the previously discussed mat 200 configurations are exemplary and non-limiting.

In an aspect, the mounting system 10 includes a module end clamp 300 used to secure PV modules 20 to the mounting system 10, as shown in FIGS. 6-9. In such aspects, the module end clamp 300 comprises materials that have desired properties, including, but not limited to, corrosion resistance, conductivity, and other such properties known in the art. As non-limiting examples, a module end clamp 300 may include Al 6000 series alloys and other materials known in the art. The module end clamp 300 may be received by a component of the mounting system 10. For example, a module end clamp 300 may be configured to be received in the slots 140 or 120 of the lower portion 130 or raised portion 110 of a mounting ridge 100.

In an aspect, a module end clamp 300 includes a rail mount component 310 and a module securing component 360, as shown in FIGS. 6-7. The rail mount component 310 includes a main body 312, a top end 314, and a bottom end 316. The top end 314 of the main body 312 of the rail mount component 310 includes an aperture 318 configured to receive a fastener 340. The bottom end 316 of the main body 312 of the rail mount component 310 may comprise side members/flanges 322 extending away from the center line of the main body 312 in a manner perpendicular to the center line of the main body 312. In an exemplary aspect of the invention, the bottom end 316 may comprise four side members/flanges 322, though additional side members/flanges 322 could be used. In a further aspect, the main body 312 of the rail mount component 310 may comprise a hollow interior channel 324 that extends through both the top end 314 and bottom end 316 of the main body 312. In such an aspect, the hollow interior channel 324 reduces material and cost requirements of a module end clamp 300 and allows for the fastener 340 to have unobstructed movement when tightening.

In an aspect, the module end clamp 300 may further comprise a fastener 340, as shown in FIG. 6. In an exemplary aspect of the invention, this fastener 340 may comprise a spring 342, which affords the fastener 340 a spring-loaded capability. The fastener 340 may comprise a variety of hardware known in the art. In an exemplary aspect, the hardware may comprise a bolt 344 and a self-tightening nut 346. The fastener 340 can be attached at the top end 314 of the rail mount component 310 through the aperture 318, with the nut 346 securing the bolt 344 on the underside of the top end 314, and the spring 342 on the bolt 344 on the opposite side.

In an aspect, the module end clamp 300 may further comprise a module securing component 360, as shown in FIG. 6. The module securing component 360 may be joined to the rail mount component 310 through means of the fastener 340 as described above. In an aspect, the module securing component 360 may comprise a top end 362 and bottom end 364 with a flange 366 extending from the top end 362 and configured to engage a PV module 20. In a further aspect, the module securing component 360 may comprise an aperture 368 to receive the fastener 340 such that the module securing component 360 may be joined to the rail mount component 310. As shown in FIG. 6, the fastener 340 is received within the aperture 368, with the head 348 of the bolt 346 being found on the upper surface of the top end 362, and the cylindrical body of the bolt on the under surface of the top end 362, surrounded by the spring 342.

The module securing component 360 may further comprise two arms 370 extending downward from the top end 362 of the module securing component 360 configured to engage the rail mount component 310. In an aspect, the module end clamp 300 is configured to be able to rotate within a slot 120 or 140 of the mounting ridge 100, which aids in installation of the module end clamp 300 and PV modules 20, as described above. In an exemplary aspect of the invention, the spring 342, bolt 344, and self-tightening nut 346 of a fastener 340 joining a rail mount component 310 to a module securing component 360 affords the module end clamp 300 the ability to secure a PV module 20 to the array mounting system 10, as shown in FIG. 7.

The module end clamp 300 may also be configured to be received in a number of other slots of additional components of the mounting system 10, as will be described below. In an exemplary aspect of the invention, a module end clamp 300 may first be inserted horizontally into a slot 120/140 of the mounting ridge 100 and then rotated 90 degrees to face towards the direction where the PV module 20 will be placed. Once rotated, a module end clamp 300 may exert pressure onto the end of a PV module 20 as to secure it to the mounting system 10. In such aspects, a module end clamp 300 may be used to secure PV modules 20 of varying thicknesses. Exemplary thicknesses may range from around 27 mm to 45 mm. Such methods will be discussed further below.

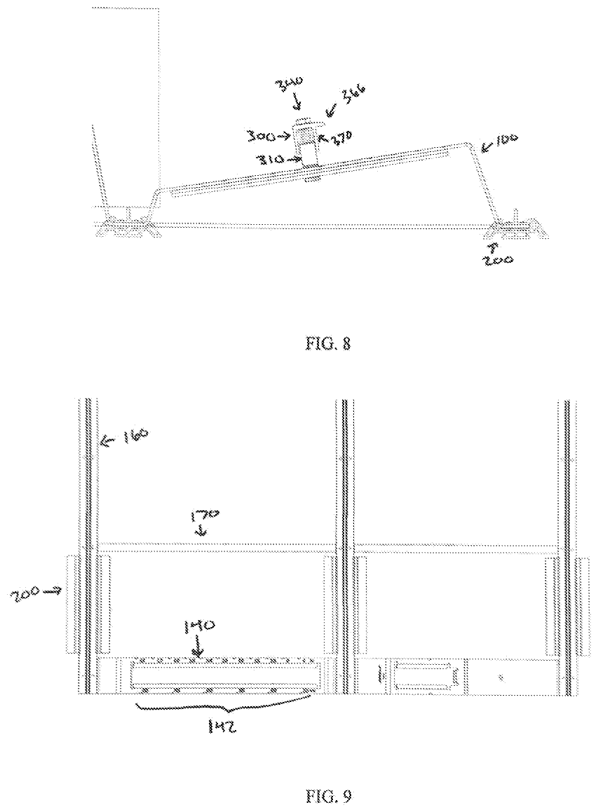

In an additional aspect, the module end clamp 300 may be moved north and south within a slot (e.g., 120/14) of a mounting component of the mounting system 10, as shown in FIGS. 8-9 and described further below. For instance, a module end clamp 300 may be moved north and south in in the slots 140 or 120 of the lower portion 130 or raised portion 110 of a mounting ridge 100, though a clamp 300 may also be moved north and south in other components, as will be described below. The ability of this north and south movement, via the slot/clamp interface, allows the mounting system 10 to have adjustable inter-row spacing capabilities. The clamp 300 can be secured in various inter-row spacing positions to prevent unwanted shading of additional PV modules 20 mounted to the system 10, which facilitate a higher density of PV modules 20 capable of being mounted onto the system 10, as shown in FIG. 13. In such an aspect, PV modules 20 can be properly spaced so that rows of PV modules 20 are as close together as possible while no shading is occurring on any PV module 20. Shading reduces electricity output generated by PV modules 20 and is undesired. Placing the PV modules 20 as close together as possible while avoiding shading maximizes array density for a roof 30 of a given size. This results in maximized electricity production.

Additionally, the inter-row spacing capability of the system 10 may facilitate greater electrical generation from a number of PV modules 20, as the inter-row spacing can be optimized to minimize shading on individual PV modules 20. In an exemplary aspect of the current invention, the inter-row spacing may range from about 8 in. up to about 18 in, though additional ranges may be possible. As non-limiting examples, inter-row spacing may range from about 9 in. up to about 17 in, about 10 in. up to about 16 in, about 1 lin. up to about 15 in, about 12 in. up to about 14 in, and any combination of ranges thereof. The above ranges allow PV modules 20 to be secured in custom positions (i.e. inter-row spacing), as defined above. By adjusting inter-row spacing within the above ranges, shading can be eliminated while array density (i.e. number of PV modules 20 capable of being mounted on a roof 30) is maximized. This combination maximizes the amount of electricity that can be created through mounting PV modules 20 to a roof 30 of a given size.

In an additional aspect, a mounting component of the mounting system 10 may comprise a hook 400, as shown in FIG. 10. For example, a mounting ridge 100 may comprise a hook 400 joined to the raised portion 110, the lower portion 130, or both, though additional mounting components may also comprise hooks 400, as will be described below. In an aspect, the hook 400 includes a mounting end 402 that is configured to be joined to a component, and an engaging end 404 opposite the mounting end 402, with the engaging end 404 configured to engage a PV module 20. By joining a hook 400 to a portion of a mounting ridge 100, installation of PV modules 20 onto the mounting system 10 is made easier by providing a temporary resting place.

In an exemplary aspect of the invention, a PV module 20 may be placed onto a hook 400, as shown in FIG. 10. This allows the PV module 20 to rest on the hook 400, via the engaging end 404, temporarily on the mounting component (e.g. mounting ridge 100) before the module end clamp 300 is properly positioned. In such an aspect, the installer may now position the module end clamp 300 to secure the PV module 20 without having to manually hold the PV module 20 in place. Once the PV module 20 has been secured to a mounting component of the mounting system 10 via the module end clamp 300, the hook 400 remains attached to the component. The hook 400 can then additionally assist in realigning modules 20 during removal and re-installation of modules 20. Such removal and re-installation may occur during routine procedures including, but not limited to, maintenance of PV modules 20.

The mounting system 10 can include additional mounting components, including a south face summit 500, as shown in FIGS. 11A-11B. The south face summit 500 may comprise similar aspects to the raised portion 110 of the mounting ridge 100. The south face summit 500 may operate as a dedicated rear piece to be placed at the back of a mounting system 10 to minimize the protrusion of PV modules 20, as shown in FIG. 13. Similar to the raised portion 110 of the mounting ridge 100, the south face summit 500 comprises two mount members 512 that further comprise an angled support member 514 and a vertical support member 516. The angled support member 514 and vertical support member 516 are connected by a horizontal support member 518, wherein the horizontal support member 518 further comprises an elongated slot 520 for receiving a module end clamp 300. The elongated slot 520 can receive a module end clamp 300 as described above, but may also be configured to receive clamps of other varieties. In an aspect, the mount members 512 of the south face summit 500 may be connected by cross members 560 that run perpendicular to the direction of the mount members 512. In an additional aspect, another set of cross members 570 may be configured to run perpendicular to the previously described cross members 560, substantially connecting the first set of cross members 560. In such an aspect, the use of two sets of cross members 560 and 570 oriented perpendicular to each other affords the south face summit 500 increased rigidity. In an aspect, a south face summit 500 can also include ballast supports 580, as described below. In an additional aspect, the south face summit 500 may be configured to be joined with mounting mats 200 in the same manner as the mounting ridge 100. In such an aspect, four mats 200 may be used; however, the south face summit 500 may be configured to use more or less than four mats 200.

The mounting system 10 may also include a south face valley component 600, as shown in FIG. 12. The south face valley 600 may comprise similar aspects to the lower portion 130 of the mounting ridge 100. The south face valley 600 may operate as a dedicated front piece to be placed at the front of a mounting system 10 to minimize the protrusion of PV modules 20, as shown in FIG. 13. Similar to the lower portion 130 of the mounting ridge 100, the south face valley 600 comprises two mount members 612 that further comprise an angled support member 614 and a vertical support member 616. The angled support member 614 and vertical support member 616 are connected by a horizontal support member 618, wherein the horizontal support member 618 further comprises an elongated slot 620 for receiving a module end clamp 300. The elongated slot 620 can receive a module end clamp 300 as described above, but may also be configured to receive clamps of other varieties. In an additional aspect, the south face valley may also comprise a flat portion 630 extending away from the mount members.

In an aspect, the mount members 612 and flat portion 630 of the south face valley 600 may be connected by cross members 660 that run perpendicular to the direction of the mount members 612. In an additional aspect, another set of cross members 670 may be configured to run perpendicular to the previously described cross members 660, substantially connecting the first set of cross members 660. In such an aspect, the use of two sets of cross members 660 and 670 oriented perpendicular to each other affords the south face valley 600 increased rigidity. In an aspect, a south face valley 600 can also include ballast supports 680, as described below. In an additional aspect, the south face valley 600 may be configured to be joined with mounting mats 200 in the same manner as the mounting ridge 100. In such an aspect, six mats 200 may be used; however, the south face valley 600 may be configured to use more or less than six mats 200. The combined method of use of the south face summit 500 and south face valley 600 serves to minimize protrusions on both the front end and back end of PV modules 20, which ultimately maximizes the density of modules to be mounted on the system 10, as shown in FIG. 13.

In an aspect, both the south face summit 500 and south face valley 600 may comprise a multi-material metal chassis, wherein the metals utilized are selected from a group comprising zinc aluminum magnesium coated steel, galvanized steel, AL 6000 series alloys, and other alloys of steel, aluminum, and other metals known to those skilled in the art.

In an aspect, the current invention may also comprise an anchor bracket 700, as shown in FIGS. 14A-14B and FIGS. 15A-15B. The anchor bracket 700 is configured to be compatible with an anchor 734 while being able to attach to the metal chassis of any of the three mounting components (i.e. mounting ridge 100, south face summit 500, or south face valley 600). An anchor 734 can aid in securing a mounting system 10 to a roof 30 while removing the need for roof-penetrating fasteners. An anchor 734 prevents movement of a mounting system 10 due to thermal and seismic stressors. An anchor 734 additionally can prevent movement or shifting of a mounting system 10 during PV module 20 mounting. An anchor may work in combination with mats 200 and ballasts 800 to maintain the position of a mounting system 10. The anchor bracket 700 is compatible with most anchors 734 known in the art including, but not limited to, OMG Powergrip Plus, UAnchor, Facet, and EcoFasten Co65. The anchor 734 received in the anchor bracket 700 may afford additional weight to the mounting system 10, thus providing additional stability of the mounting system 10 on the roof 30. The anchor bracket 700 may be inserted anywhere within the square metal chassis of a mounting component 100, 500, 600, which affords the anchor bracket 700 ten (10) inches of east and west adjustability. In addition to east and west adjustability, the anchor bracket 700 affords north and south adjustability, as described further below.

In an aspect, an anchor bracket 700 comprises a length 710 and a width 720, as shown in FIGS. 15A-15B. The anchor bracket 700 comprises a body 730 extending the length 710 of the bracket 700. The body 730 is configured to comprise an elongated slot 732 in the center of the body 730, wherein the elongated slot 732 is configured to receive the anchor 734. In such an aspect, the anchor 734 received in the elongated slot 732 may be received in such a way as to allow the anchor 734 to directly abut the roof 30. In one aspect, the elongated slot 732 affords the anchor bracket 700 at least five (5) inches of north and south adjustability, as the anchor 734 can be secured at different positions along the groove 732. However, other ranges of adjustability can be utilized by different aspects of the invention. The anchor 734 may be secured within the elongated slot 732 by means of a fastener 736, which will depend on the anchor 734 utilized. Exemplary anchors 734 known in the art are provided above. Located on either side of the body 730 are flanges 740 joined to the body 730, wherein the flanges 740 extend perpendicular to the length 710 of the body 730. At either end of the flanges 740 are located notches 742, wherein the notches further comprise grooves 744. The grooves 744 are configured to receive portions of the metal chassis of a mounting component selected from a mounting ridge 100, south face summit 500, and a south face valley 600. In such aspects as described above, the anchor bracket 700 may comprise materials that are corrosion resistant. Such materials may comprise zinc aluminum magnesium coated steel, galvanized steel, stainless steels, other alloys of steel, AL 6000 series alloys and other materials known in the art.

In an aspect, the mounting components (i.e. mounting ridge 100, south face summit 500, and south face valley 600) of the mounting system 10 are configured to receive ballasts 800, as shown in FIGS. 14A-14D. In such aspects, one or more ballasts 800 may be secured within a chassis of a mounting component through ballast supports 180, 580, 680. Such supports 180, 580, 680 provide stability to ballasts so that they do not fall out of the chassis of a mounting component. The ballasts 800 add weight to the mounting components as to secure them to the roof 30. A ballast 800 can aid in securing a mounting system 10 to a roof 30 while removing the need for roof-penetrating fasteners. A ballast 800 prevents movement of a mounting system 10 due to thermal and seismic stressors. A ballast 800 additionally can prevent movement or shifting of a mounting system 10 during PV module 20 mounting. A ballast 800 may work in combination with mats 200 and anchors 734 to maintain the position of a mounting system 10. As a non-limiting example, mounting components 100, 500, 600 may be secured to the roof 30 by one or more ballasts 800 by counteracting wind loads using the ballasts 800 weight. Such use of one or more ballasts 800 may negate the need for roof-penetrating mounting components. Ballasts 800 are placed on the chasses of the mounting components, wherein the weight of the ballast 800 is significant enough to secure the ballasts' 800 positions. In such aspects, the weight of one or more ballasts 800 is designed to be of a weight that is enough to secure a mounting system 10 but not to compromise the structural integrity of a roof 30. This designing process included wind tunnel testing of a mounting system 10 comprising one or more ballasts 800 to achieve lower uplift coefficients than are prescribed from structural code ASCE-7. In such an aspect, lower uplift coefficients result in lower ballast 800 requirements and less weight on the roof 30. Wind tunnel testing was performed on both portrait and landscape orientations of the mounting system 10.

In such aspects as described above, the use of mounting mats 200, anchor brackets 700, and ballasts 800 is sufficient to secure a mounting system 10 to a roof 30 without the need for penetrating the roof 30, as shown in FIGS. 14A-14D. In this manner, the mounting system 10 of the current invention prevents damage to the roof and eradicates the need for fasteners extending into the roof while also inhibiting movement of the system 10 due to thermal stress, seismic loads, or caterpillaring.

In an aspect, the mounting components (i.e. mounting ridge 100, south face summit 500, and south face valley 600) of the mounting system 10 may comprise a Universal Module Frame Mounting Kit (UMFMK) 900. The UMFMK 900 may mount directly onto a PV module 20, as shown in FIG. 16. The mounting components (i.e. mounting ridge 100, south face summit 500, and south face valley 600) of the mounting system 10 may also be configured to receive accessory mounting hardware (AMH) 910 through the use of a variety of apertures in the mounting components, as shown in FIGS. 14A, 14C, and 17. FIG. 17 displays an aperture 115 on a vertical support member 116 of a mounting ridge 100, wherein the aperture 115 is configured to receive an AMH 910. FIGS. 14A and 14C further display aspects wherein AMH 910 is mounted to a south face summit 500 through the use of an aperture 515.

Once mounted, the AMH 910 may be used to attach a variety of accessories to the mounting system 10, wherein the accessories may comprise direct current power optimizers, microinverters, module-level power electronics, fire skirts, or wind skirts, though other accessories may also be used. In such an aspect, the AMH 910 may comprise may comprise materials that are corrosion resistant and conductive. Such materials may comprise zinc aluminum magnesium coated steel, galvanized steel, stainless steels, other alloys of steel, AL 6000 series alloys and other materials known in the art.

Having thus described exemplary embodiments of the present invention, it should be noted by those skilled in the art that the disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A photovoltaic (PV) mounting system comprising:
a. a mounting component configured to receive a photovoltaic module;
b. mounting mats configured to be mounted to a roof and receive the mounting component; and,
c. a securing device, wherein the securing device secures the photovoltaic module onto the mounting component.

2. The PV mounting system of claim 1, wherein the mounting component further comprises a mounting ridge with a mounting ridge comprising a bottom and cross members, the cross members received by the mounting mats.

3. The mounting system of claim 2, wherein the mounting ridge further comprises;
a. a first mounting portion raised to support the one end of a photovoltaic module;
b. a second mounting portion to support a second, opposing end of a photovoltaic module; and,
c. support members running perpendicular to the cross members to offer additional rigidity.

4. The mounting system of claim 2, wherein the mounting ridge comprises a plurality of mounting ridges configured to be stackable with one another.

5. The mounting system of claim 1, wherein the mounting component, the mounting mats, and securing device are configured to allow bay-style photovoltaic mounting.

6. The mounting system of claim 1, wherein the system prevents the roof from being damaged.

7. The mounting system of claim 1, wherein the system is configured for use on flat roofs or commercial roofs.

8. The mounting system of claim 1, wherein the photovoltaic modules can be mounted in either portrait or landscape configurations.

9. The mounting system of claim 1, wherein the system is configured to receive ballasts or anchors to secure the system without need for penetrating the roof.

10. The mounting system of claim 9, wherein an anchor may be configured to be adjusted in the north, east, south, and west directions.

11. The mounting system of claim 1, wherein inter-row spacing of a photovoltaic array is adjustable by adjusting a position of the securing device within the mounting system.

12. The mounting system of claim 1, wherein the mounting mat comprises a plurality of mounting mats configured to be stackable with one another.

13. The mounting system of claim 12, wherein mounting mats are configured to be stackable with one another during installment of the system to provide height adjustment for the mounting ridge.

14. The mounting system of claim 13, wherein the mounting mats comprise:
a. a mounting channel, configured to retain a cross member of the mounting component;
b. stabilizing side arms configured to engage a top surface of a roof
c. a hollow middle channel configured to expand and contract to dissipate thermal expansion and seismic loads;
d. a bottom stabilizing member configured to allow for a plurality of mounting mats to be stackable with one another; and,
e. bottom side channels configured to expand and contract to dissipate thermal expansion and seismic loads.

15. The mounting system of claim 1, wherein the securing device comprises a module end clamp comprising:
a. a rail mount component configured to interface with the mounting component;
and,
b. a module securing component configured to engage with a mounted PV module.

16. The mounting system of claim 15, wherein the rail mount component is configured to be adjustably received within a slot of the mounting ridge.

17. A fully-adjustable, bay-styled, multi-component photovoltaic mounting system for use on flat or commercial roofs, wherein the mounting system can receive photovoltaic modules in either portrait or landscape configurations, the system comprising:
a. At least one mounting summit, wherein the mounting summit is configured to receive a portion of a photovoltaic module;
b. At least one mounting ridge, wherein the mounting ridge is configured to receive a second portion of a photovoltaic module;
c. At least one mounting valley, wherein the mounting valley is configured to receive a third portion of a photovoltaic module;
d. A plurality of mounting mats, wherein the mounting mats are configured to receive cross members on the bottom of a mounting summit, ridge, or valley; and,
e. A plurality of securing devices, wherein the securing devices secure the portions of a photovoltaic module onto the mounting summit, ridge, or valley.

18. The multi-component mounting system of claim 17, wherein the system is configured to receive ballasts or anchors to secure the system without need for penetrating the roof.

19. The multi-component mounting system of claim 17, wherein the inter-row spacing of a photovoltaic array can be chosen by adjusting the securing device's position within the mounting system.

20. The multi-component mounting system of claim 17, wherein the system is configured to receive a Universal Module Frame Mounting Kit or accessory mounting hardware (AMII) capable of mounting a variety of accessories.

21. The multi-component mounting system of claim 20, wherein the variety of accessories can be selected from a group consisting of microinverters, wind skirts, or fire skirts.

22. The multi-component mounting system of claim 17, wherein the mounting summit comprises hooks for a photovoltaic module to rest on before engaging a securing device.

23. A method of mounting photovoltaic modules onto a roof, wherein the method prevents damaging the roof and thermal migration of the module, the method comprising:
a. Arranging a fully-adjustable photovoltaic mounting system onto the roof;
b. Positioning the photovoltaic module onto the mounting system; and,
c. Engaging a securing device of the mounting system to secure the photovoltaic module.

24. The method of claim 23, wherein the photovoltaic module is first positioned onto a hook of the mounting system prior to engaging the securing device.

25. The method of claim 23, wherein the inter-row spacing of a photovoltaic array can be selected by adjusting the position of a securing device while mounting.
